(19) United States
(12) Patent Application Publication
(10) Pub. No.: US 2007/0165130 A1
(43) Pub. Date: Jul. 19, 2007

(54) Optical input and/or control device

(75) Inventors: Louis Marie Hubert Cobben, Geldrop (NL); Bernardus Hendrikus Wilhelmus Hendriks, Eindhoven (NL); Stein Kuiper, Eindhoven (NL); Winslow Michael Mimnagh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 11/568,394

(22) PCT Filed: Apr. 25, 2005
(86) PCT No.: PCT/IB05/51336

§ 371 Date: Oct. 27, 2006

(30) Foreign Application Priority Data
Apr. 29, 2004 (EP) 04101852.4

(51) Int. Cl. G02B 13/16

(52) U.S. Cl. 348/335

(57) ABSTRACT

An optical input and/or control de and/or actuating variable functions of, for examp device, the optical input and/or control device ha radiation from a diode laser (3) is converged. As across the window (12), part of the scattered radi due to the movement of the finger (15), re-enters measured using the self-mixing effect of the lase radiation emitted by the laser (3) and re-entering of the laser and thus in the radiation emitted by photo-diode (4) which converts the radiation vari circuitry is provided which processes this signal. ice for manually selectively controlling e, an image capture device or a computer mg a transparent window (12) on which an object, e.g. a user's finger (15), moves tion, whose frequency is Doppler-shifted the laser cavity. Relative movement is diode (3), which is the phenomenon that e laser cavity induces a variation in gain e laser (3). The change can be detected by a tion into an electric signal and electronic

This invention relates to an optical input and/or control device for selective actuation and/or control of various functions, the device being of the type which includes a relative movement sensor for measuring movement of an object and said sensor relative to each other, the sensor comprising at least one laser, having a laser cavity, for generating a measuring beam and illuminating an object therewith, wherein at least some of the measuring beam radiation reflected by said object re-enters said laser cavity, the apparatus further comprising measuring means for measuring changes in operation of said laser cavity caused by interference of reflected measuring beam radiation re-entering said laser cavity and the optical wave in said laser cavity, means for providing an electric signal representative of said changes.

A relative movement sensor of this type is, for example, disclosed in International Patent Application No. WO 02/37410, in which is described an optical input device having a transparent window on which radiation from a diode laser is converged. As an object, for example a user's finger, moves across the window, part of the radiation scattered by the object, whose frequency is Doppler-shifted due to the movement of the object, re-enters the laser cavity. Relative movement of the input device and the object is measured using the so-called self-mixing effect in a diode laser. This is the phenomenon that radiation emitted by the diode laser and re-entering the cavity of the diode laser induces a variation in gain of the laser and thus in the radiation emitted by the laser. This change can be detected by a photo-diode which converts the radiation variation into an electric signal and electronic circuitry is provided which processes this signal.

In a specific exemplary embodiment of the arrangement described in the above-mentioned document, the relative movement sensor may be used provide an optical replacement for the mechanical track ball function of a conventional input device or mouse for a computer.

It is an object of the present invention to provide an optical input and/or control means for various selectively actuatable and controllable functions, which are more reliable and robust than their mechanical counterparts.

In accordance with a first aspect of the present invention, there is provided an image capture device comprising one or more variable optical functions, and wherein said variable optical functions are selectively actuated and/or controlled by an optical input and/or control device in the form of a relative movement sensor for measuring movement of an object and said sensor relative to each other along at least one measuring axis, the sensor comprising at least one laser, having a laser cavity, for generating a measuring beam and illuminating an object therewith, wherein at least some of the measuring beam radiation reflected by said object re-enters said laser cavity, the apparatus further comprising measuring means for measuring changes in operation of said laser cavity caused by interference of reflected measuring beam radiation re-entering said laser cavity and the optical wave in said laser cavity, means for providing an electric signal representative of said changes, wherein said variable optical functions are selectively actuated and/or controlled by movement of said object and said sensor relative to each other.

The first aspect of the present invention also extends to a method of selectively actuating and/or controlling one or more optical functions of the image capture device as defined above. The first aspect of the present invention extends still further to a portable telecommunications device incorporating an image capture device as defined above.

In a preferred embodiment, the optical input and/or control device is arranged and configured to permit selective manual control of a variable focus lens, and/or the selective switching on and off of a filter, such as an infra-red filter or the like.

According to a second aspect of the present invention, there is provided an optical input and/or control device comprising one or more optical actuation means for selecting one or more functions using said optical input device, the or each actuation means comprising a relative movement sensor for measuring movement of a user's finger and said sensor relative to each other along at least one measuring axis, the sensor comprising at least one laser, having a laser cavity, for generating a measuring beam and illuminating said user's finger therewith, wherein at least some of the measuring beam radiation reflected by said object re-enters said laser cavity, the apparatus further comprising measuring means for measuring changes in operation of said laser cavity caused by interference of reflected measuring beam radiation re-entering said laser cavity and the optical wave in said laser cavity, means for providing an electric signal representative of said changes, the or each optical actuation means actuatable being operable by movement of said user's finger relative to said relative movement sensor in a manner which simulates actuation of an analogous mechanical actuation means.

The second aspect of the present invention also extends to a method of selecting one or more functions using an optical input device as defined above, the method comprising moving a user's finger relative to the relative movement sensor in a manner which simulates actuation of an analogous mechanical actuation means.

In one embodiment, the device preferably comprises first and second optical actuation means, wherein the first and second optical actuation means are individually arranged and configured to determine and respond to a click action by a single movement of the finger and the sensor relative to each other along an axis, which is substantially perpendicular to the finger surface, in a substantially similar manner to mechanical click button, the optical actuation means together being arranged and configured to determine and respond to a scroll action by movement of the finger and the sensor in a direction substantially parallel to the surface of the finger, in a substantially similar manner to a mechanical scroll wheel

In the case of both the first and second aspects, the direction of movement along the at least one measuring axis may be detected by determining the shape of the signal representing the variation in operation of the laser cavity. Alternatively, the direction of movement along the at least one measuring axis may be determined by supplying the laser cavity with a periodically varying electric current and comparing first and second measuring signals with each other, which first and second measuring signals are generated during alternating first half periods and second half periods, respectively. In a preferred embodiment, these first and second measuring signals may be subtracted from each other.

In an exemplary embodiment, the relative movement sensor may be arranged and configured to determine and respond to a click action by a single movement of the object and the sensor relative to each other along an axis, which is substantially perpendicular to the object surface. In another embodiment, the relative movement sensor may be arranged and configured to determine and respond to a scroll action of the object and the sensor relative to each other in a direction parallel to the object surface. One or more relative movement sensors may be arranged and configured to determine and respond to both a click action and a scroll action, by movement of the object and the sensor relative to each other in a first direction substantially parallel to the object surface and in a second direction substantially perpendicular to the object surface, as required by the application.

The relative movement may be measured by measuring the impedance of the laser cavity, and/or the intensity of the laser radiation.

These and other aspects of the present invention will be apparent from, and elucidated with reference to, the embodiments described herein.

Embodiments of the present invention will now be described by way of examples only and with reference to the accompanying drawings, in which:

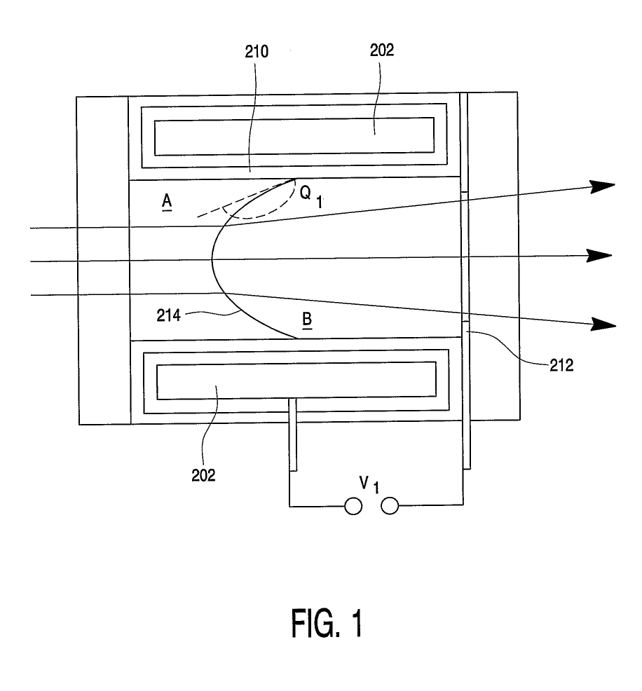

FIG. 1 is a schematic view of a variable focus lens;

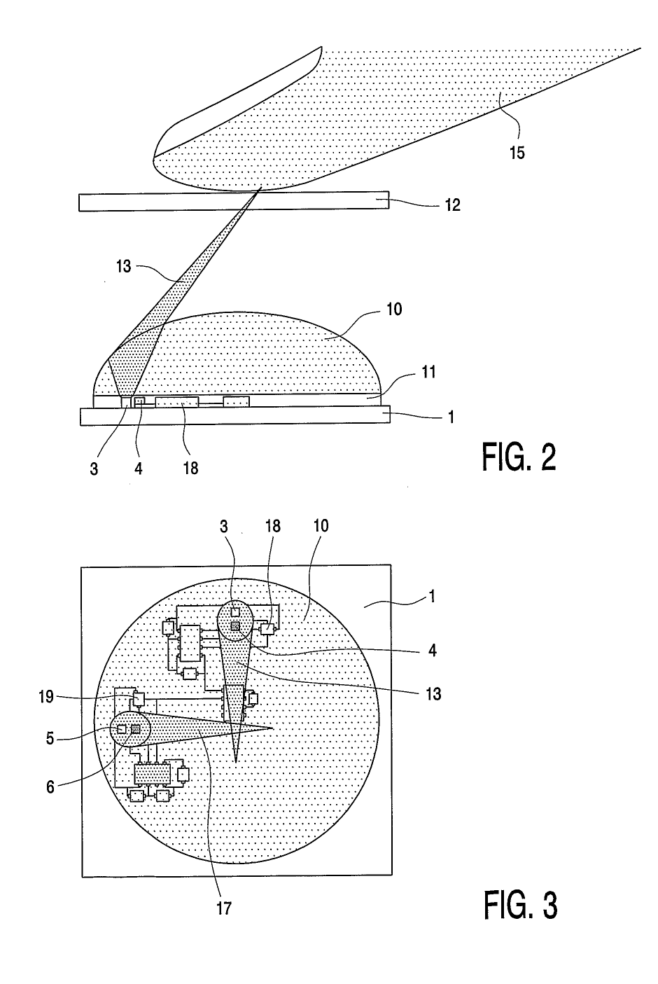

FIG. 2 is a schematic cross-sectional view of a control device for use in an image capture device according to an exemplary embodiment of the present invention;

FIG. 3 is a plan view of the device of FIG. 2;

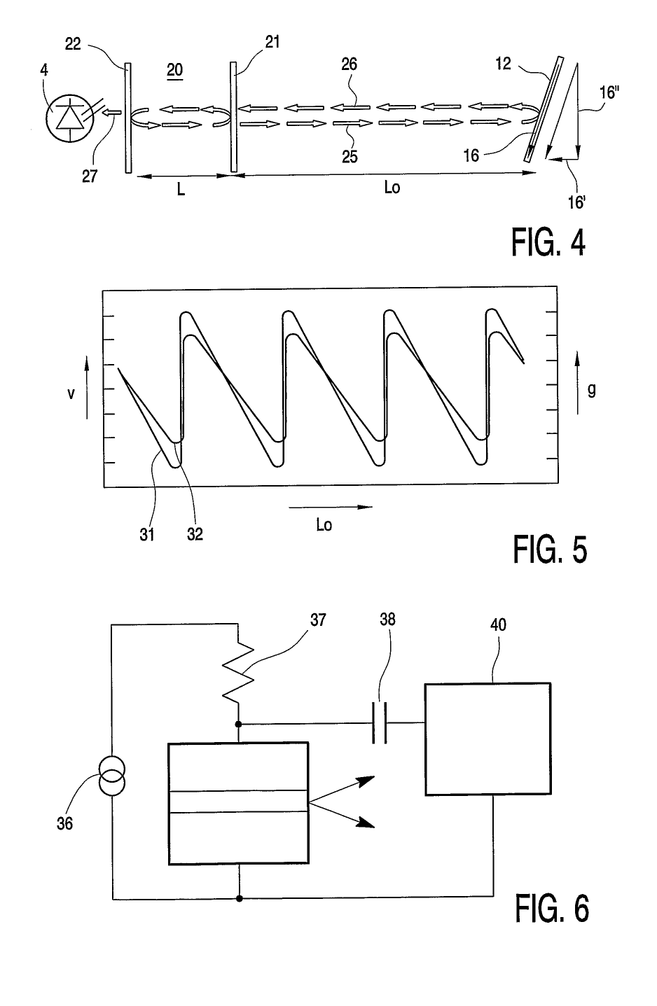

FIG. 4 illustrates schematically the principle of the measuring method of the control device of FIGS. 2 and 3;

FIG. 5 shows the variation of the optical frequency and the gain of the laser cavity as a function of the movement of the device and the object relative to each other; and

FIG. 6 illustrates a method of measuring this variation;

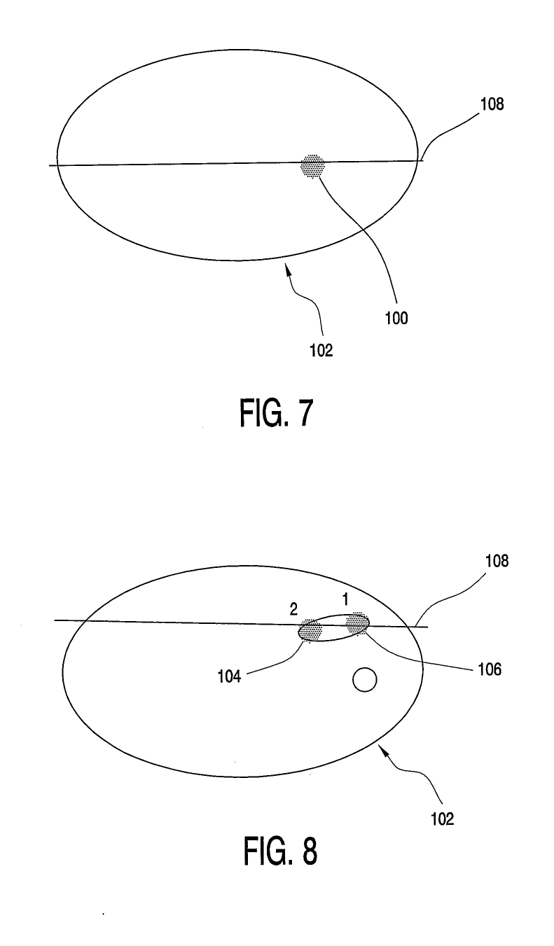

FIG. 7 is a schematic bottom view of a computer mouse including a single optical relative movement sensor in place of a conventional track ball sensor; and

FIG. 8 is a schematic plan view of a computer mouse including two optical relative movement sensors operating in place of a conventional “click” button.

The miniaturization and incorporation of image capture devices in various portable devices, such as mobile telephones and the like, is increasing. Currently, image capture devices having a relatively low resolution (i.e. a pixel density of, say, around 640×480 pixels) are being used, with the result that a focusing function is not really required to be provided, and the lens used tends to be a fixed focus lens.

However, as pixel density is increasing to megapixel densities, it is becoming highly desirable to provide some form of focusing function to exploit the full capability of such a high pixel density. An automatic focusing function is well known in the field of image capture devices which, in most cases, is sufficient to refocus the system automatically, such that in general no manual adjustment is required. However, in cases where the surrounding light intensity is low, contrast is low, or under backlight conditions, this type of autofocus function no longer operates adequately, such that there is a need to provide a manual focusing function. Furthermore, if a zoom lens is provided, manual adjustment of the zoom factor is required to be provided.

In order to address these issues, it is possible to provide a variable focus lens, particularly suitable for use in providing a focus and/or zoom lens for portable image capture applications, such as that disclosed in International Patent Application No. WO 03/069380. Referring to FIG. 1 of the drawings, this document describes a variable focus lens comprising a first fluid A and a second, non-miscible, fluid B in contact over a meniscus. A first electrode 202 separated from the fluid bodies by a fluid contact layer 210, and a second electrode 212 in contact with the first fluid to cause an electrowetting effect whereby the shape of the meniscus 214 is altered.

Furthermore, in the case of image capture devices, it is well known that, although the human eye can correct automatically for the effect on an image of infra-red light, a conventional image capture device cannot. Thus, it has been proposed to provide therein an infra-red filter to correct for the effect on an image of infra-red light by filtering such light out. However, this reduces the amount of light actually reaching the camera, such that when surrounding light intensity is low (e.g. in the evening) it is highly desirable to switch the infra-red filter off.

In all of these cases, the problem arises as to how such selective functionality is to be actuated and/or controlled, particularly in the case of miniaturized image capture devices and the like incorporated in portable telecommunications devices, wherein space consumption is a critical issue. Mechanical control systems exist (for scrolling and clicking), but these tend to consume too much space to be suitable applications such as those mentioned above. In addition, such devices tend to be sensitive to contamination and often look and/or feel unattractive.

It is therefore an object of the first aspect of the present invention to provide a compact manual control device for selective manual actuation and/or control of various functions in an image capture device, especially suitable for incorporation a portable telecommunications device or the like and, in an exemplary embodiment, the present invention is particularly concerned with the provision of a compact manual control device for use in applications such as manual control of a focus and/or zoom lens, such as the electrowetting lens described above, or in the selective switching on and off of an infra-red filter, for example, whereby the control device is compact and substantially insensitive to contamination.

In order to achieve this object, it is proposed to provide a control device having a transparent window on which radiation from a diode laser is converged. As an object, for example a user's finger, moves across the window, part of the radiation scattered by the object, whose frequency is Doppler-shifted due to the movement of the object, re-enters the laser cavity. Relative movement of the input device and the object is measured using the so-called self-mixing effect in a diode laser. This is the phenomenon that radiation emitted by the diode laser and re-entering the cavity of the diode laser induces a variation in gain of the laser and thus in the radiation emitted by the laser. This change can be detected by a photo-diode which converts the radiation variation into an electric signal and electronic circuitry is provided which processes this signal.

The principle of operation, and general structure, of such a control device for use in an exemplary embodiment of the present invention will now be described with reference to FIGS. 2 to 6 of the drawings.

FIG. 2 is a diagrammatic cross-section of the input or control device. The device comprises at its lower side a base plate 1, which is a carrier for the diode lasers, in this embodiment lasers of the type VCSEL, and the detectors, for example photo diodes. In FIG. 2 only one diode laser 3 and its associated photo diode 4 is visible, but usually at least a second diode laser 5 and associated detector 6 is provided on the base plate, as shown in the FIG. 3 top view of the apparatus. The diode lasers 3 and 5 emit laser, or measuring, beams 13 and 17, respectively. At its upper side the device is provided with a transparent window 12 across which an object 15, for example a human finger is to be moved. A lens 10, for example a plano-convex lens is arranged between the diode lasers and the window. This lens focuses the laser beams 13 and 17 at or near the upper side of the transparent window. If an object 15 is present at this position, it scatters the beam 13. A part of the radiation of beam 13 is scattered in the direction of the illumination beam 13 and this part is converged by the lens 10 on the emitting surface of the diode laser 3 and re-enters the cavity of this laser. As will be explained hereinafter, the radiation returning in the cavity induces changes in this cavity, which results in, inter alia, a change of the intensity of the laser radiation emitted by the diode laser. This change can be detected by the photo diode 4, which converts the radiation variation into an electric signal, and an electronic circuitry 18 for processing this signal. The illumination beam 17 is also focused on the object, scattered thereby and part of the scattered radiation re-enters the cavity of the diode laser 5. The circuitry 18 and 19, for the signal of the photo diode 6, shown in FIGS. 2 and 3 has only an illustrative purpose and may be more or less conventional. As is illustrated in FIG. 3, this circuitry is interconnected.

FIG. 4 illustrates the principle of the input device and the method of measuring according to the present invention when a horizontal emitting diode laser and a monitor photo diode arranged at the rear facet of the laser are used. In this figure, the diode laser, for example diode laser 3 is schematically represented by its cavity 20 and its front and rear facets, or laser mirrors, 21 and 22, respectively. The cavity has a length L. The object, whose movement is to be measured, is denoted by reference numeral 15. The space between this object and the front facet 21 forms an external cavity, which has a length L₀. The laser beam emitted through the front facet is denoted by the reference numeral 25 and the radiation reflected by the object in the direction of the front facet is denoted by reference numeral 26. Part of the radiation generated in the laser cavity passes through the rear facet and is captured by the photo diode 4.

If the object 15 moves in the direction of the illumination beam 13, the reflected radiation 26 undergoes a Doppler shift. This means that the frequency of this radiation changes or that a frequency shift occurs. This frequency shift is dependent on the velocity with which the object moves and is of the order of a few kHz to MHz. The frequency-shifted radiation re-entering the laser cavity interferes with the optical wave, or radiation generated in this cavity, i.e. a self-mixing effect occurs in the cavity. Dependent on the amount of phase shift between the optical wave and the radiation re-entering the cavity, this interference will be constructive or negative, i.e. the intensity of the laser radiation is increased or decreased periodically. The frequency of the laser radiation modulation generated in this way is exactly equal to the difference between the frequency of the optical wave in the cavity and that of Doppler-shifted radiation re-entering the cavity. The frequency difference is of the order of a few kHz to MHz and thus easy to detect. The combination of the self-mixing effect and the Doppler shift causes a variation in the behavior of the laser cavity; especially its gain, or light amplification, varies.

This is illustrated in FIG. 5. In this figure, curves 31 and 32 represent the variation of the frequency ν of the emitted laser radiation and the variation of the gain g of the diode laser, respectively, as a function of the distance L₀ between the object 15 and the front mirror 21. Both ν, g and L₀ are in the arbitrary units. As the variation of the distance L₀ is the result of movement of the object, the abscissa of FIG. 5 can be re-scaled in a time axis, so that the gain will be plotted as a function of time. The gain variation Δg as a function of the velocity ν of the object is given by the following equation:

$$Δ g = - \frac{K}{L} \cdot cos \cdot \{ \frac{4 πυ \cdot v \cdot t}{c} + \frac{4 π \cdot {L}_{0} \cdot t}{c} \}$$

In this equation:
K is the coupling coefficient to the external cavity; it is indicative of the quantity of radiation coupled out of the laser cavity;
ν is the frequency of the laser radiation;
v is the velocity of the object in the direction of the illumination beam
t is the moment of time, and
c is the light velocity.

The equation can be derived from the theory on the self-mixing effect disclosed in the two articles mentioned herein above. The object surface is moved in its own plane, as is indicated by the arrow 16 in FIG. 4. Because the Doppler shift occurs only for an object movement in the direction of the beam, this movement 16 should be such that it has a component 16′ in this direction. Thereby, it becomes possible to measure the movement in an XZ plane, i.e. the plane of drawing of FIG. 4 which movement can be called the X movement. FIG. 4 shows that the object surface has a skew position with respect to the rest of the system. In practice, usually the measuring beam is a skew beam and the movement of the object surface will take place in a XY-plane. The Y-direction is perpendicular to the plane of the drawing in FIG. 4. The movement in this direction can be measured by a second measuring beam, emitted by a second diode laser, and scattered light of which is captured by a second photo diode associated with the second diode laser. A (the) skew illumination beam(s) is (are) obtained by arranging the diode laser(s) eccentrically with respect to the lens 10, as shown in FIG. 2.

Measuring the variation of the laser cavity gain caused by the object movement by measuring the intensity of the radiation at the rear laser facet by a monitor diode is the simplest, and thus the most attractive way. Conventionally, this diode is used for keeping the intensity of the laser radiation constant, but now it is also used for measuring the movement of the object.

Another method of measuring the gain variation, and thus the movement of the object, makes use of the fact that the intensity of the laser radiation is proportional to the number of electrons in the conduction band in the junction of the laser. This number in turn is inversely proportional to the resistance of the junction. By measuring this resistance, the movement of the object can be determined. An embodiment of this measuring method is illustrated in FIG. 6. In this figure, the active layer of the diode laser is denoted by the reference numeral 35 and the current source for supplying this laser is denoted by reference numeral 36. The voltage across the diode laser is supplied to an electronic circuit 40 via a capacitor 38. This voltage, which is normalized with the current through the laser, is proportional to the resistance, or impedance, of the laser cavity. The inductance 37 is series with the diode laser forms high impedance for the signal across the diode laser.

Besides the amount of movement, i.e. the distance across which the object is moved and which can be measured by integrating the measured velocity with respect to time, also the direction of movement has to be detected. This means that it has to be determined whether the object moves forward or backward along an axis of movement. The direction of movement can be detected by determining the shape of the signal resulting from the self-mixing effect. As shown by graph 32 in FIG. 5, this signal is an asymmetric signal. The graph 32 represents the situation where the object 15 is moving towards the laser. The rising slope 32′ is steeper than the falling slope 32″. As described in the above-mentioned article in Applied Optics, Vol. 31, No. 8, Jun. 20, 1992, pages 3401-3408, the asymmetry is reversed for a movement of the object away from the laser, i.e. the falling slope is steeper than the rising slope. By determining the type of asymmetry of the self-mixing signal, the direction of movement of the object can be ascertained. Under certain circumstances, for example for a smaller reflection coefficient of the object or a larger distance between the object and the diode laser, it may become difficult to determine the shape or asymmetry of the self-mixing signal.

The control device described above, in its simplest form, may comprise a laser-based scrolling device that can be compact (3-5 mm in diameter), robust and self-aligning. In this simple form, it can detect up/down movements of the finger that is moved along the device. The resulting signal can, for example, be used to directly, manually focus an electrowetting lens, such as that described above, on an object or subject located nearby or far away. Similarly, the resultant signal can be used to directly zoom in or out with respect to a subject using a zoom lens, which may also operate using the electrowetting principle described above.

A conventional mouse for use as an input device for a computer generally comprises a combination of a track ball sensor (for moving a cursor around on a computer screen in accordance with movement of the mouse across a surface), mechanical “click” buttons, and a scroll wheel for navigation control. The optical input device described above, in relation to International Patent Application No. WO 02/37410, employs a very small optical relative movement sensor 100 in place of the conventional track ball sensor, as illustrated in FIG. 7 of the drawings, which has the effect of improving precision of the respective mouse function, and reliability of the overall device.

In accordance with an exemplary embodiment of the second aspect of the present invention, such optical relative movement sensors may also be used to replace the conventional “click” buttons and/or the scroll wheel function of a conventional computer mouse, to create an entirely optical, non-mechanical device. Referring to FIG. 8 of the drawings, two optical relative movement sensors 104, 106 may be incorporated into the computer mouse 102 to replace the two conventional “click” button functions, in which a +z −z movement of the user's finger is analogous to a “click” to actuate the function. A similar configuration may be used to replace the conventional scroll wheel function.

The “click” button function provided by sensors 104 and 106 in FIG. 8 operates as follows. If the user moves their finger from 1 to 2 (sensor 106 to sensor 104), the result is a single “scroll” movement (−y) while a movement from 2 to 1 results in a corresponding (+y) movement. Position 1 replaces the first conventional “click” button, wherein a +z−z movement or “click” will activate the button function. Similarly, Position 2 replaces the second conventional “click” button, wherein a +z−z movement or “click” will activate the button function.

For ergonomic reasons, positions 1 and 2 can be located at a non-zero angle to the central axis 108.

With such an advanced optical input device, containing at least two lasers, up/down and clicking functions for control of the above-mentioned image capture functions become available. This allows for a user interface between the electrowetting-based (zoom) auto-focus lens, for example. In this way, all kinds of settings can now be addressed, like changing resolution of the sensor, switching the above-mentioned infra-red filter on/off, switching between autofocus and manual focus, changing image sensor readout settings, etc.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An image capture device comprising one or more variable optical functions, and wherein said variable optical functions are selectively actuated and/or controlled by an optical input and/or control device in the form of a relative movement sensor for measuring movement of an object (15) and said sensor relative to each other along at least one measuring axis, the sensor comprising at least one laser (3), having a laser cavity, for generating a measuring beam (13) and illuminating an object (15) therewith, wherein at least some of the measuring beam radiation reflected by said object re-enters said laser cavity, the apparatus further comprising measuring means (4) for measuring changes in operation of said laser cavity caused by interfence of reflected measuring beam radiation re-entering said laser cavity and the optical wave in said laser cavity, and means for providing an electric signal representative of said changes, wherein said variable optical functions are selectively actuated and/or controlled by movement of said object (15) and said sensor relative to each other.

2. A device according to claim 1, wherein the optical input and/or control device is arranged and configured to permit selective manual control of a variable focus lens.

3. A device according to claim 1, wherein the optical input and/or control device is arranged and configured to permit selective manual control of a variable zoom lens.

4. A device according to any one of claims 1 to 3, wherein the optical input and/or control device is arranged and configured to permit the selective switching on and off of a filter.

5. A device according to claim 4, wherein said filter comprises an infra-red filter.

6. A device according to any one of claims 1 to 5, wherein the direction of movement along the at least one measuring axis is detected by determining the shape of the signal representing the variation in operation of the laser cavity.

7. A device according to any one of claims 1 to 5, wherein the direction of movement along the at least one measuring axis is determined by supplying the laser cavity with a periodically varying electric current and comparing first and second measuring signals with each other, which first and second measuring signals are generated during alternating first half periods and second half periods, respectively.

8. A device according to claim 7, wherein the first and second measuring signals may be subtracted from each other.

9. A device according to any one of claims 1 to 8, wherein the relative movement sensor is arranged and configured to determine and respond to a click action by a single movement of the object (15) and the sensor relative to each other along an axis, which is substantially perpendicular to the object surface.

10. A device according to any one of claims 1 to 8, wherein the relative movement sensor is arranged and configured to determine and respond to a scroll action of the object (15) and the sensor relative to each other in a direction parallel to the object surface.

11. A device according to any one of claims 1 to 10, wherein one or more relative movement sensors are arranged and configured to determine and respond to both a click action and a scroll action, by movement of the object (18) and the sensor relative to each other in a first direction substantially parallel to the object surface and in a second direction substantially perpendicular to the object surface.

12. A device according to any one of claims 1 to 11, wherein the relative movement is measured by measuring the impedance of the laser cavity.

13. A device according to any one of claims 1 to 11, wherein the relative movement is measured by measuring the intensity of the laser radiation.

14. A portable telecommunications device incorporating an image capture device according to any one of claims 1 to 13.

15. A method of selectively actuating and/or controlling one or more optical functions of the image capture device according to any one of claims 1 to 13, the method comprising measuring movement of an object (15) and a relative movement sensor relative to each other along at least one measuring axis, the sensor comprising at least one laser (3) having a laser cavity, for generating a measuring beam (13) and illuminating an object (15) therewith, wherein at least some of the measuring beam radiation reflected by said object re-enters said laser cavity, the method further comprising measuring changes in operation of said laser cavity caused by interference of reflected measuring beam radiation re-entering said laser cavity and the optical wave in said laser cavity, providing an electric signal representative of said changes, and selectively actuating and/or controlling said variable optical functions by effecting movement of said object (15) and said sensor relative to each other.

16. An optical input and/or control device comprising one or more optical actuation means for selecting one or more functions using said optical input device, the or each actuation means comprising a relative movement sensor for measuring movement of a user's finger (15) and said sensor relative to each other along at least one measuring axis, the sensor comprising at least one laser (3), having a laser cavity, for generating a measuring beam (13) and illuminating said user's finger (15) therewith, wherein at least some of the measuring beam radiation reflected by said object re-enters said laser cavity, the apparatus further comprising measuring means (4) for measuring changes in operation of said laser cavity caused by interference of reflected measuring beam radiation re-entering said laser cavity and the optical wave in said laser cavity, means for providing an electric signal representative of said changes, the or each optical actuation means actuatable being operable by movement of said user's finger (15) relative to said relative movement sensor in a manner which simulates actuation of an analogous mechanical actuation means.

17. A device according to claim 16, wherein the direction of movement along the at least one measuring axis may be detected by determining the shape of the signal representing the variation in operation of the laser cavity.

18. A device according to claim 16, wherein the direction of movement along the at least one measuring axis may be determined by supplying the laser cavity with a periodically varying electric current and comparing first and second measuring signals with each other, which first and second measuring signals are generated during alternating first half periods and second half periods, respectively.

19. A device according to claim 18, wherein the first and second measuring signals may be subtracted from each other.

20. A device according to any one of claims 16 to 19, wherein the relative movement sensor is arranged and configured to determine and respond to a click action by a single movement of the user's finger (15) and the sensor relative to each other along an axis, which is substantially perpendicular to the object surface.

21. A device according to any one of claims 16 to 19, wherein the relative movement sensor is arranged and configured to determine and respond to a scroll action of the user's finger (15) and the sensor relative to each other in a direction parallel to the object surface.

22. A device according to any one of claims 16 to 21, wherein one or more relative movement sensors are arranged and configured to determine and respond to both a click action and a scroll action, by movement of the user's finger (15) and the sensor relative to each other in a first direction substantially parallel to the object surface and in a second direction substantially perpendicular to the object surface.

23. A device according to any one of claims 16 to 22, wherein the relative movement is measured by measuring the impedance of the laser cavity.

24. A device according to any one of claims 16 to 22, wherein the relative movement is measured by measuring the intensity of the laser radiation.

25. A method of selecting one or more functions using an optical input device according to any one of claims 16 to 24, the method comprising moving a user's finger (15) relative to the relative movement sensor in a manner which simulates actuation of an analogous mechanical actuation means.
